(19) United States
(12) Patent Application Publication
(10) Pub. No.: US 2019/0152302 A1
(43) Pub. Date: May 23, 2019

(54) Solar Shield Apparatus for Windshield

(71) Applicants: Betty Howard, La Palma, CA (US); Reatha Howard, Los Angeles, CA (US); Anita Green, Whittier, CA (US)

(72) Inventors: Betty Howard, La Palma, CA (US); Reatha Howard, Los Angeles, CA (US); Anita Green, Whittier, CA (US)

(21) Appl. No.: 15/986,986

(22) Filed: May 23, 2018

Related U.S. Application Data
(60) Provisional application No. 62/589,344, filed on Nov. 21, 2017.

(51) Int. Cl. B60J 3/02; B60J 3/04

(52) U.S. Cl. CPC B60J 3/0286; B60J 3/04

(57) ABSTRACT

A solar shield apparatus for an automobile windshield includes a housing having a bottom wall and plurality of side walls that define an interior area. The housing is removably coupled to a mounting base via mounting brackets such that the housing is selectively released from the mounting base when the mounting base is coupled to a cabin ceiling of the automobile adjacent the windshield. A solar shield panel having a flexible and tinted construction is movable by a spool in the housing between retracted and deployed configurations. A guide channel extending downwardly from the housing along a side of the windshield guides the solar shield panel when being deployed or retracted. The solar shield panel may be motorized via actuation buttons or moved manually. A mechanical retraction assembly may be coupled to the spool to enable spring-actuated means for retracting the shield panel.

### REFERENCE TO RELATED APPLICATIONS

This application claims the priority of provisional patent application U.S. Ser. No. 62/589,344 filed Nov. 21, 2017 titled Solar Shield Apparatus for Windshield and which is incorporated herein by reference.

### BACKGROUND OF THE INVENTION

This invention relates generally to window tinting systems and, more particularly, to a solar shield apparatus for selectively controlling or shielding sunlight from passing through an automobile windshield.

The glare of bright sunlight through an automobile windshield is perhaps the greatest challenge to a driver of an automobile. At certain times of the year, sunlight shining directly into a driver's eyes through the front windshield of an automobile can be so intense and overwhelming as to cause the driver to pull over, to change his schedule for commuting to work, or to risk having an accident. At times, wearing sunglasses or flipping the traditional sun visor into position is simply inadequate to shield a driver's eyes from the glare of driving into the sunlight.

Various attempts have been made for tinting or darkening the glass of an automobile windshield or at least portions thereof, including the use of photochromic and transition lens materials (see U.S. Pat. No. 6,536,828). Although presumably effective for their intended purposes, the existing proposals and patents have not effectively satisfied a driver's need to selectively obtain a tinting of an automobile windshield in positions where needed, that is easy to select between use or non-use, and which is easy to install or remove from a vehicle windshield as an aftermarket accessory.

Therefore, it would be desirable to have a solar shield apparatus that is selectively installed to an interior of an automobile windshield and selectively deployed to shield a driver's eyes from direct sunlight. Further, it would desirable to have a solar shield apparatus having a housing that is mountable at the juncture of an automobile cabin sealing and top of the windshield and which contains a tinted yet transparent shield panel selectively deployed from or retracted into the housing.

### SUMMARY OF THE INVENTION

A solar shield apparatus for an automobile windshield according to the present invention includes a housing having a bottom wall and plurality of side walls that define an interior area. The housing is removably coupled to a mounting base via mounting brackets such that the housing is selectively released from the mounting base when the mounting base is coupled to a cabin ceiling of the automobile adjacent the windshield. A solar shield panel having a flexible and tinted construction is movable by a spool in the housing between retracted and deployed configurations. A guide channel extending downwardly from the housing along a side of the windshield guides the solar shield panel when being deployed or retracted. The solar shield panel may be motorized via activation buttons or may be activated manually. A mechanical retraction assembly may be coupled to the spool to enable spring-actuated means for retracting the shield panel.

Therefore, a general object of this invention is to provide a solar shield apparatus for installation as an aftermarket accessory in an automobile and which enables a driver to deploy a tinted sheet across an entire field of vision as needed.

Another object of this invention is to provide a solar shield apparatus, as aforesaid, in which a tinted sheet may be completely retracted when not in use.

Still another object of this invention is to provide a solar shield apparatus, as aforesaid, that is easily installed and easily removable from an automobile.

A further object of this invention is to provide a solar shield apparatus, as aforesaid, that provides for virtually hands free deployment or retraction of the tinted sheet so as not to distract a driver.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a solar shield apparatus for an automobile windshield according to a preferred embodiment of the present invention, illustrated installed in the interior cabin of an automobile and positioned in a deployed configuration;

FIG. 2 is another perspective view of the solar shield apparatus as in FIG. 1 illustrated in a retracted configuration;

FIG. 3a is an exploded view of the solar shield apparatus removed from the automobile;

FIG. 3b is an isolated view on an enlarged scale taken from FIG. 3a;

FIG. 4a is a perspective view of a mounting base removed from the solar shield apparatus;

FIG. 4b is an isolated view on an enlarged scale taken from FIG. 4a;

FIG. 5 is a perspective view of the solar shield apparatus as in FIG. 1 removed from the automobile, illustrated in a fully deployed configuration;

FIG. 6 is a perspective view of the solar shield apparatus as in FIG. 5, illustrated in a partially deployed configuration;

FIG. 7a is a side view of the solar shield apparatus as in FIG. 5;

FIG. 7b is an isolated view on an enlarged scale taken from FIG. 7a;

FIG. 8a is a side view of the solar shield apparatus as in FIG. 6;

FIG. 8b is an isolated view on an enlarged scale taken from FIG. 8a;

FIG. 9a is a rear view of the solar shield apparatus as in FIG. 5;

FIG. 9b is a sectional view taken along line 9b-9b of FIG. 9a;

FIG. 9c is an isolated view on an enlarged scale taken from FIG. 9b;

FIG. 10a is an isolated perspective view of a spool assembly mounted inside a housing;

FIG. 10b is an exploded view of the spool assembly as in FIG. 10a;

FIG. 11a is another isolated perspective view of a spool assembly mounted inside a housing according to a motor-driven embodiment;

FIG. 11b is an exploded view of the spool assembly as in FIG. 11a;

FIG. 11c is an isolated view on an enlarged scale taken from FIG. 11b;

FIG. 12a is a front view of the solar shield apparatus as in FIG. 5;

FIG. 12b is a sectional view taken along line 11b-11b of FIG. 11a;

FIG. 12c is an isolated view on an enlarged scale taken from FIG. 11b; and

FIG. 13 is a block diagram illustrating the electric components of the solar shield apparatus.

### DESCRIPTION OF THE PREFERRED EMBODIMENT

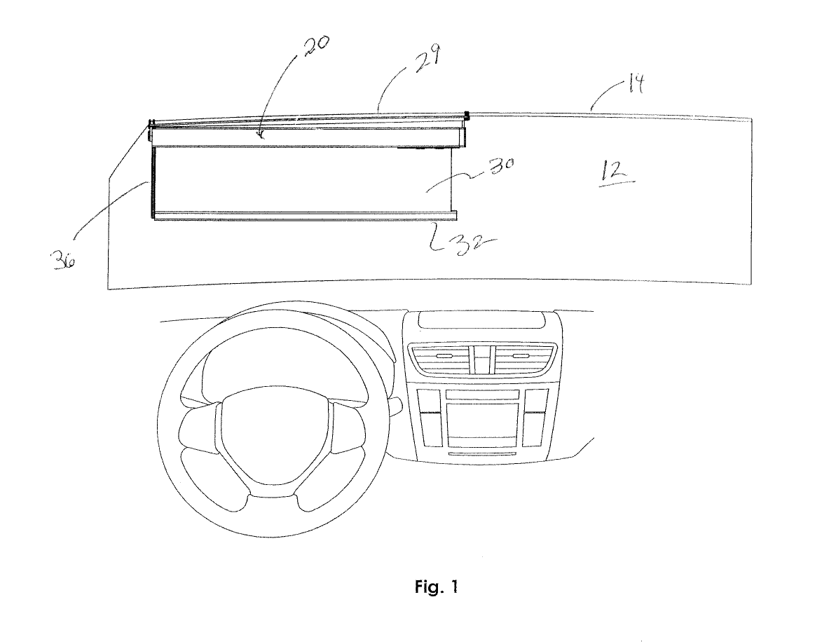

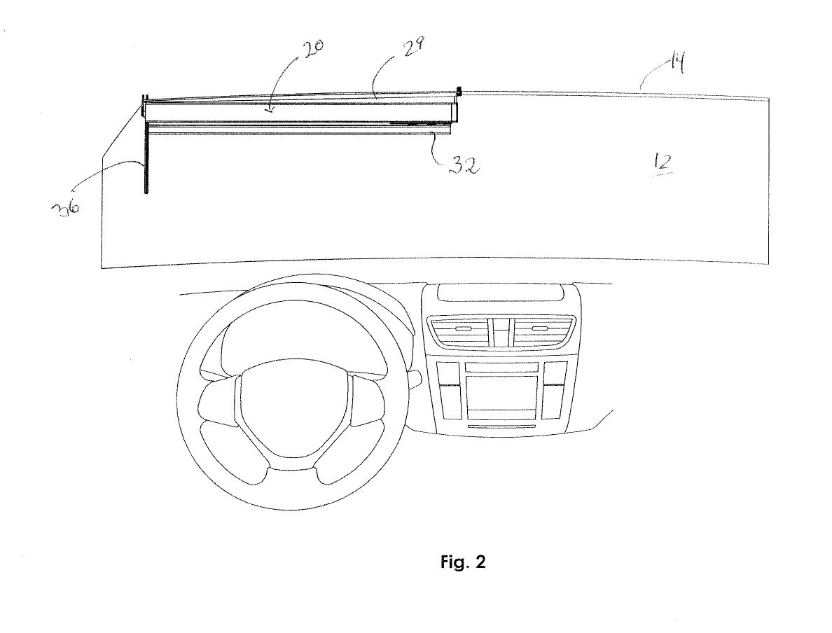

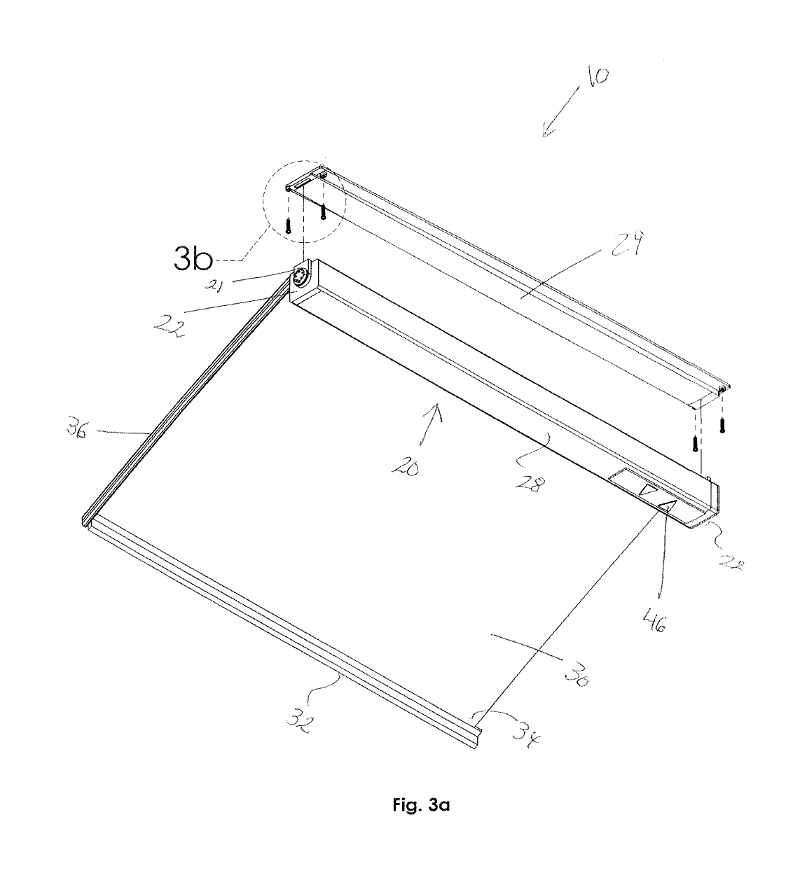

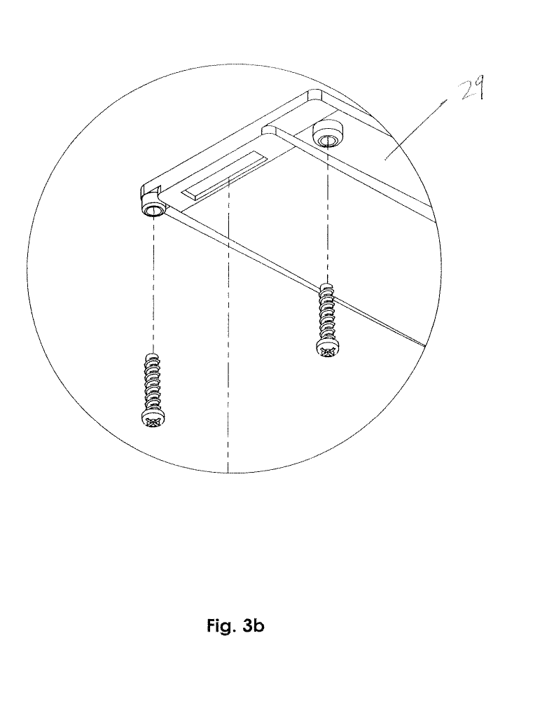

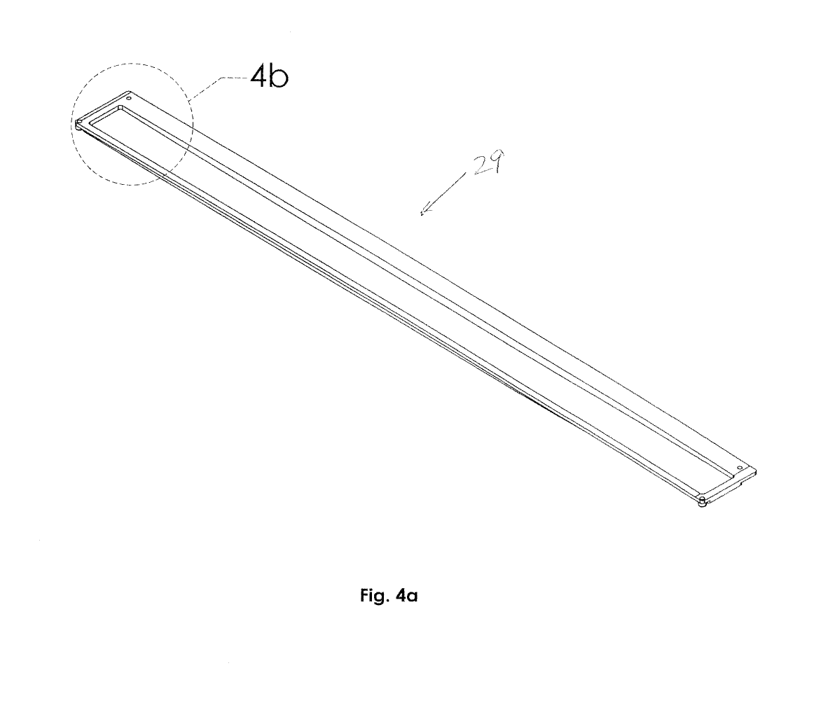

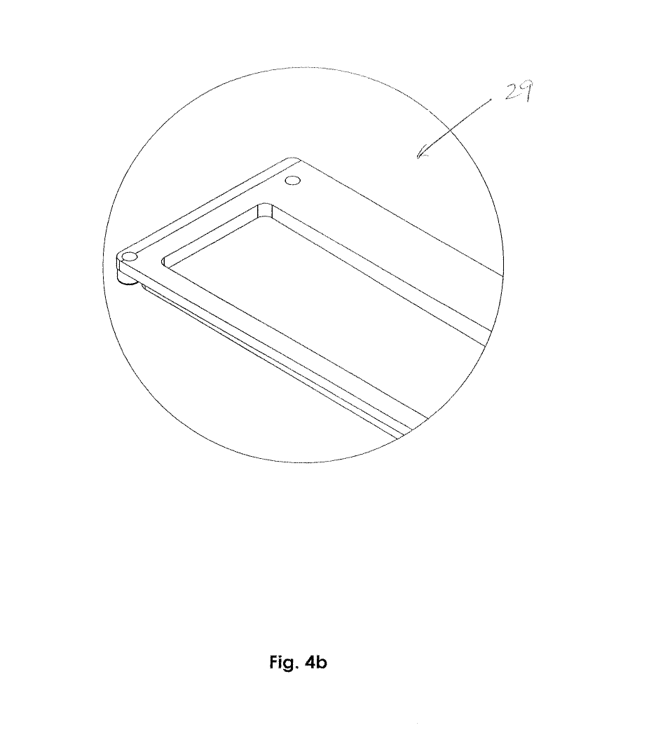

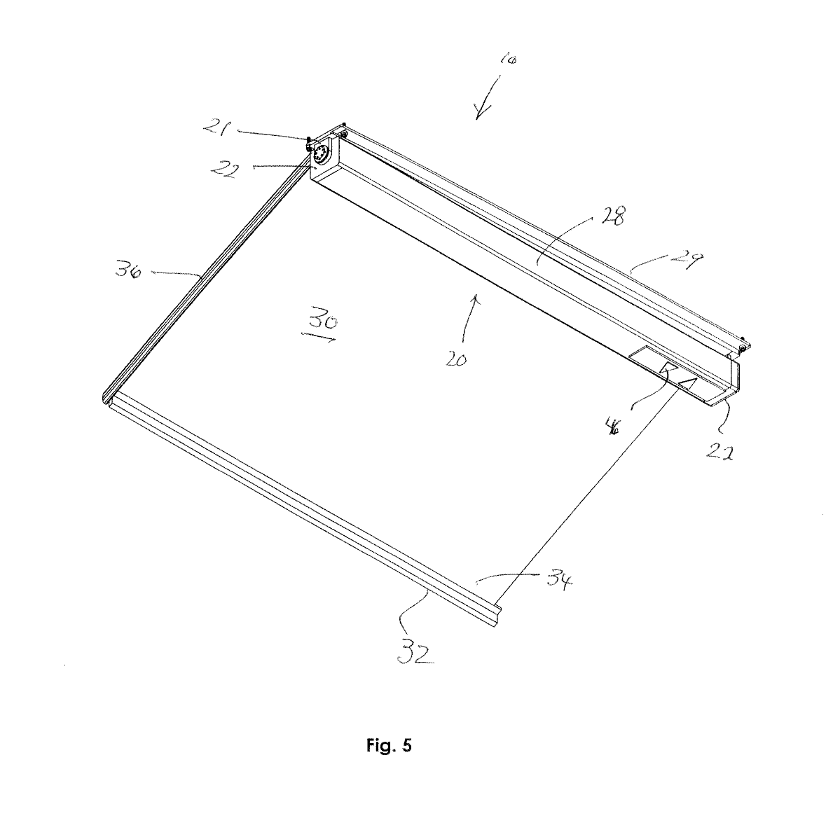

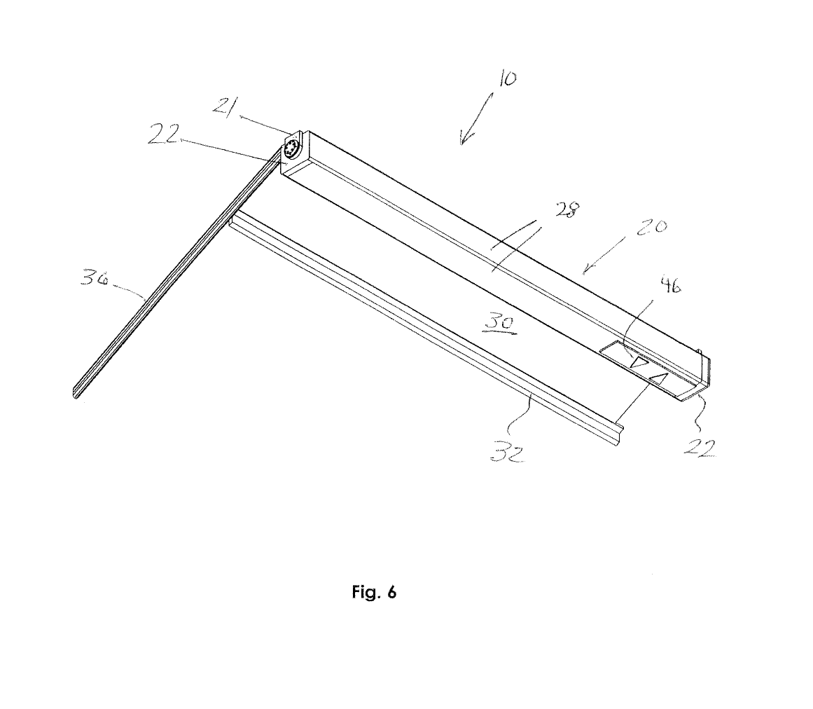

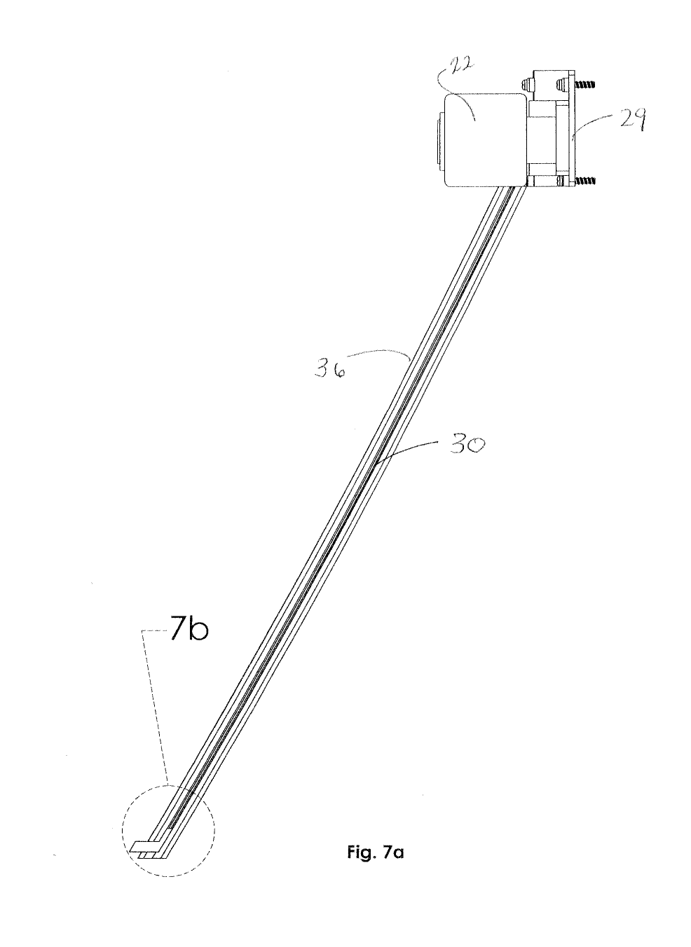

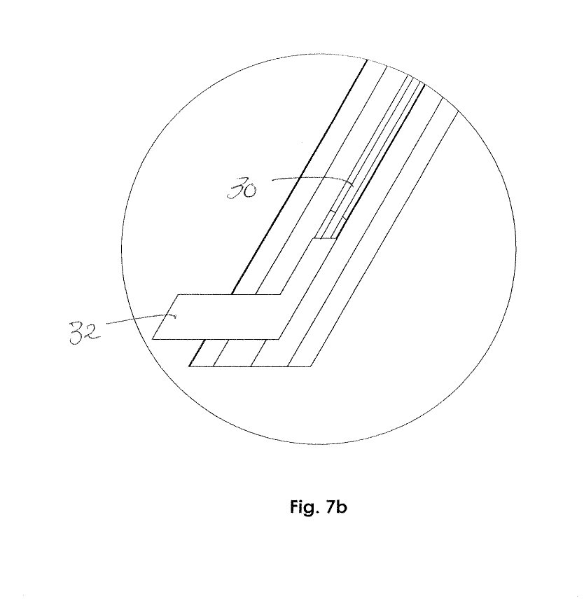

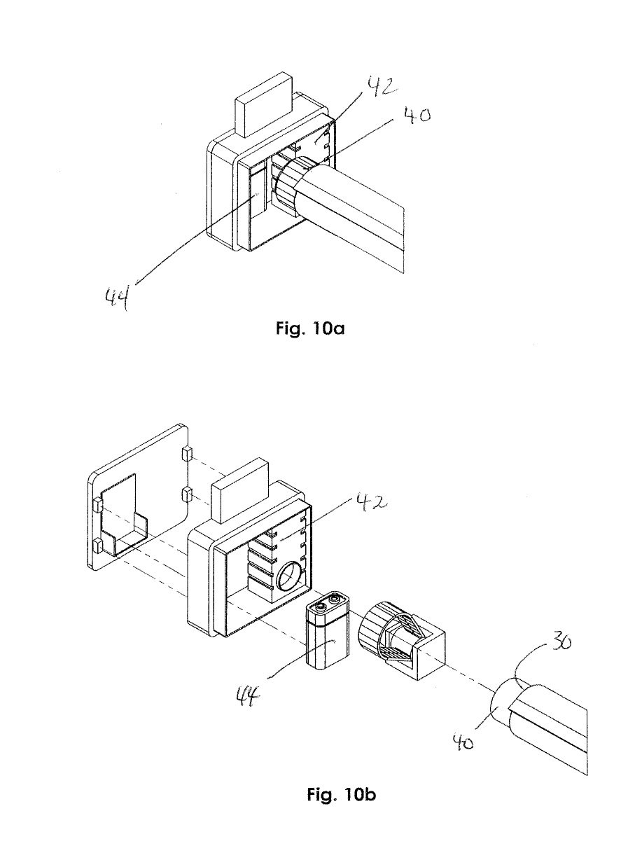

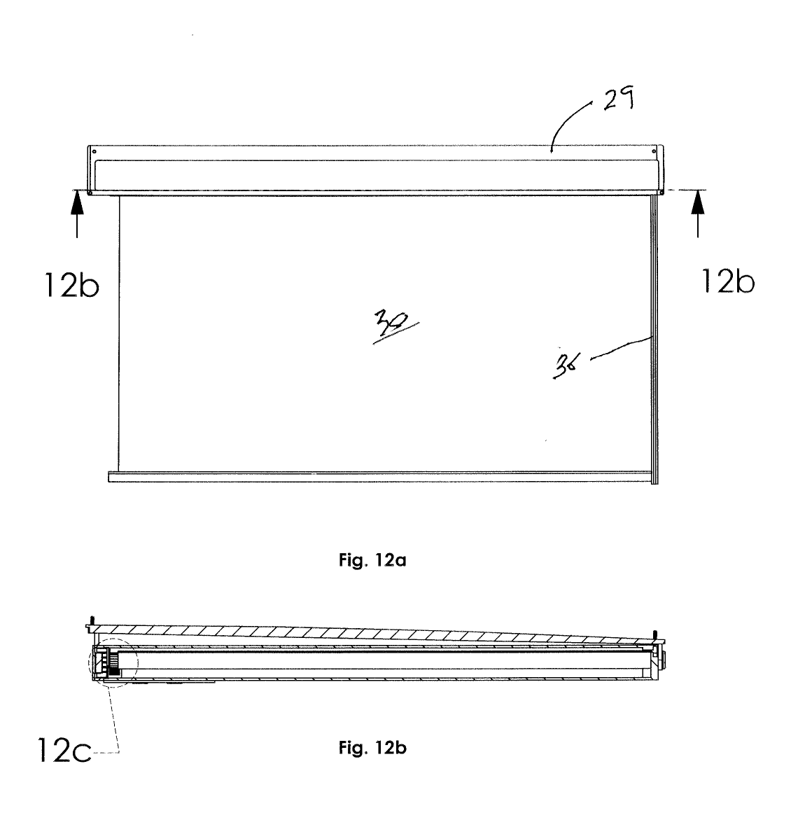

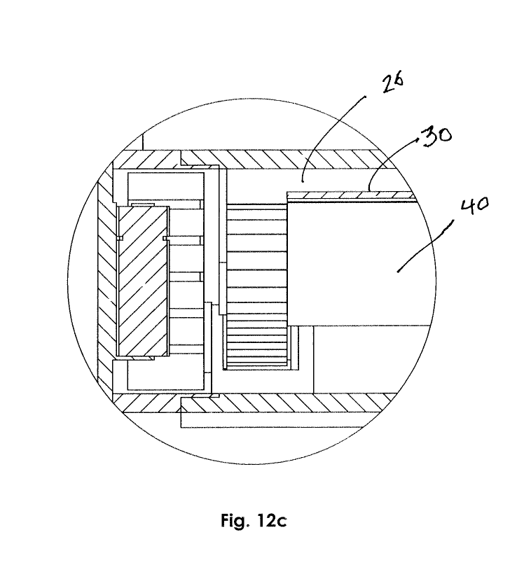

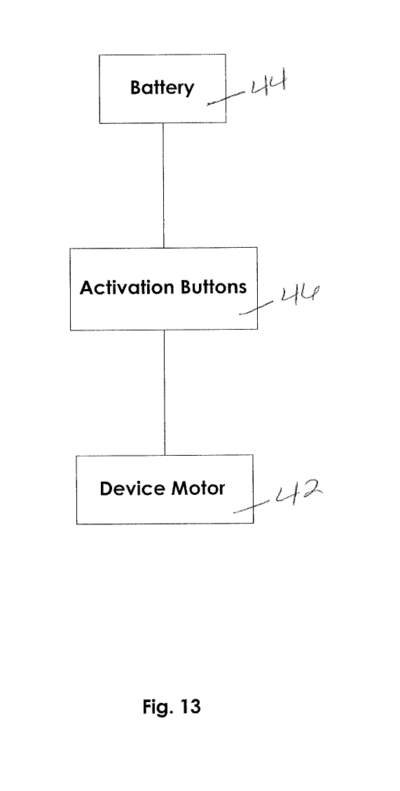

A solar shield apparatus for an automobile windshield according to a preferred embodiment of the present invention will now be described in detail with reference to FIGS. 1 to 13 of the accompanying drawings. The solar shield apparatus includes a shield housing 20, mounting base 29, and a sun shield panel 30 movable relative to the shield housing 20.

The solar shield apparatus 10 is configured for use with an automobile having a windshield 12 and a cabin ceiling 14. As will be described below, the attachment of the present invention is critical to its use, effectiveness, portability, and function. The solar shield apparatus 10 includes a shield housing 20 having a bottom wall 24, a plurality of side walls 28 and a pair of opposed end walls 22 arranged in a configuration that, collectively, defines an open interior area suitable for receiving various components of the invention as will be detailed below.

The shield housing 20 may include a pair of mounting brackets 21 or other fasteners coupled to opposed end walls 22, respectively. The bottom wall 24 may define a slot 26 extending completely between respective end walls 22 through which the sun shield panel 30 may pass as will be described later in more detail. A mounting base 29 is coupled to the mounting brackets 21 with fasteners or in a friction fit engagement. The mounting base 29 may itself be permanently or semi-permanently coupled to the inner surface of the cabin ceiling 14 adjacent the upper end of the windshield of the automobile (FIG. 1).

Accordingly, the shield housing 20 may be quickly and removably coupled to the mounting base 29, such as for removal from the automobile when not needed or to install it in another vehicle. For instance, there are certain times of the year when the angle of the sun in the early morning hours is directly in the eyes of a commuter. During this time, he may wish to have the shield housing 20 coupled to the mounting base 29 and ready for use, while at other times of the year he may wish to remove it altogether.

The shield panel 30 may have a flexible plastic construction that may be selectively folded about a spool 40 and unfolded in use, the shield panel 30 being substantially transparent such that a person driving an automobile may see through it clearly. The shield panel 30 may be operatively coupled to the shield housing 20 and selectively movable between a retracted configuration positioned substantially inside the interior area of the shield housing 20 and a deployed configuration substantially outside the interior area of the shield housing 20. The shield panel 30 may itself be constructed of or coated with a heavily tinted material, such as material having photochromic properties.

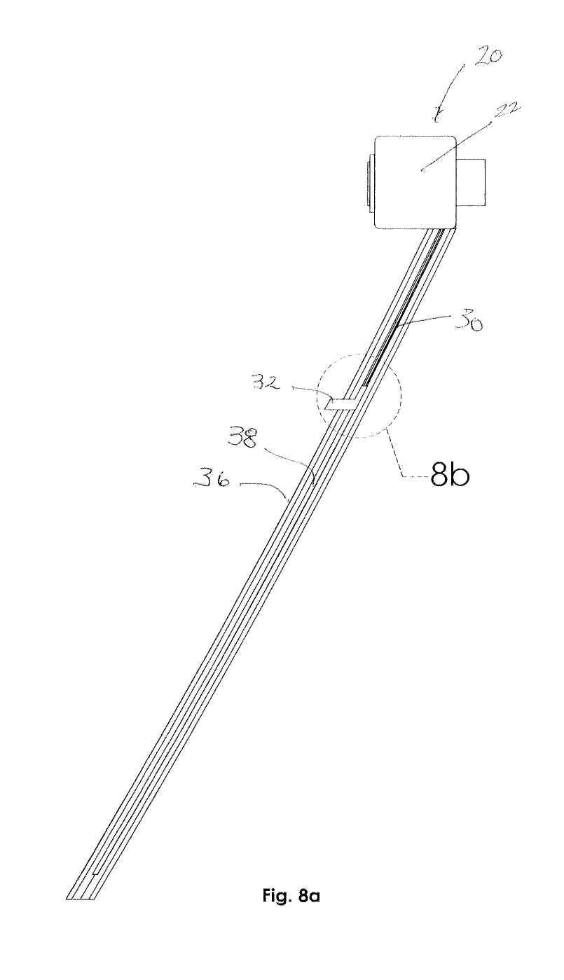

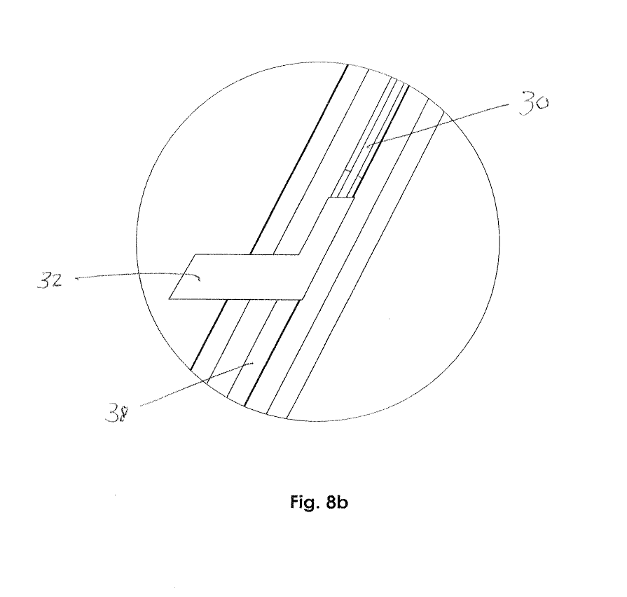

Further, the solar shield apparatus 10 further includes a guide member 36 having a proximal end coupled to a first end of the housing 20 and having an elongate configuration extending away from the housing 20. The guide member 36 is configured to extend along the windshield 12 of the automobile when the mounting base 29 is attached to the interior surface of the cabin ceiling 14 (FIG. 1). The guide member 36 defines a channel 38 in communication with a side edge of the shield panel 30 and configured to guide the shield panel 30 therealong when the shield panel 30 is moved between the retracted configuration and the deployed configuration and vice versa (FIG. 8a).

In addition, the shield panel 30 includes a handle 32 or tab attached to a free edge 34 of the shield panel 30 that may be grasped by a user and configured to urge the side panel 30 to move along the guide member 36 to a desired position. The handle 32 may extend substantially between side edges of the shield panel 30 and may have an ergonomic configuration that is easy to grasp by a user (FIGS. 8a and 8b). The handle 32 or tab has a dimension and/or configuration that is larger than a dimension of the slot 26 in the shield housing 20 such that the handle 32 cannot be received therethrough into the interior area of the shield housing 20.

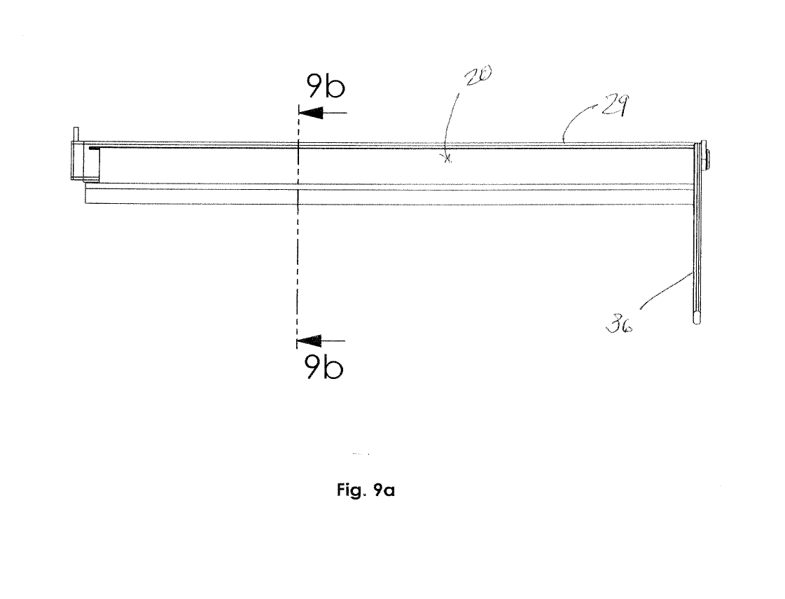

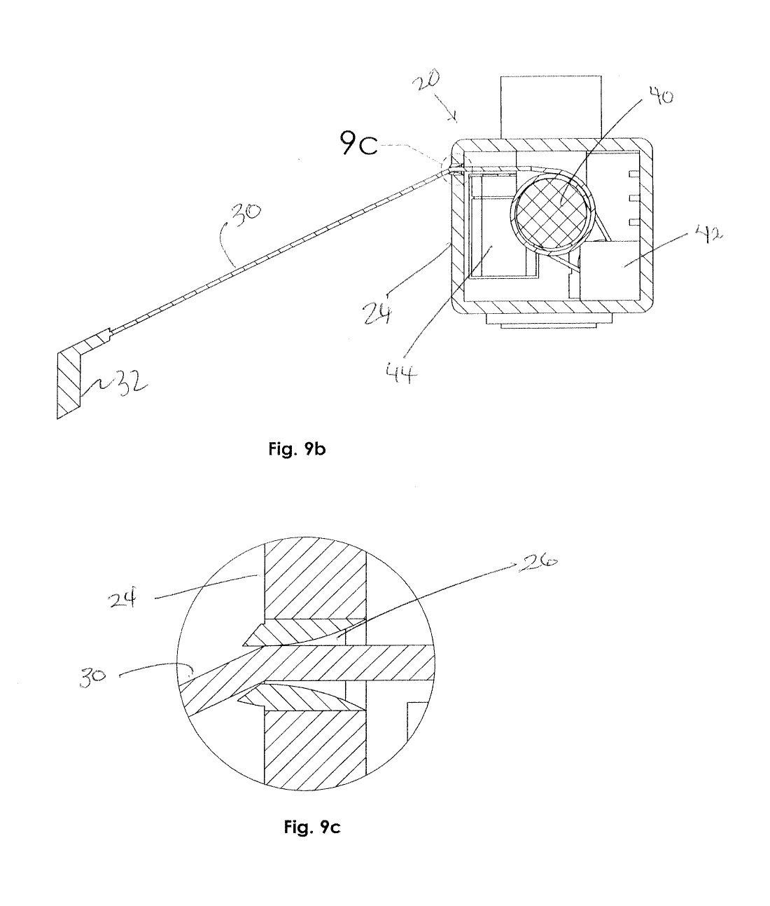

As mentioned above, the solar shield apparatus 10 includes a spool 40 rotatably mounted in the interior area of the shield housing 20 so as to be rotatable and to receive the flexible shield panel 30 thereabout or to deploy it therefrom (FIG. 9b). In an embodiment, a motor 42 may be situated in the interior area of the shield housing 20 and operatively coupled to the spool 40. The motor 42 may be energized selectively in a forward or reverse direction such that the spool 40 is operated accordingly when the motor 42 is energized, i.e. when it receives current. A battery 44 may be situated in the shield housing 20 (or external in some embodiments) and electrically connected to the motor 42, the battery 44 selectively providing current to the motor 42 when actuated. In addition, a plurality of activation buttons may be positioned on an exterior surface of the shield housing 20 and electrically connected to said motor 42, the buttons being configured to actuate the motor 42 to operate the spool 40 and the shield panel 30 between the retracted and deployed configurations, respectively.

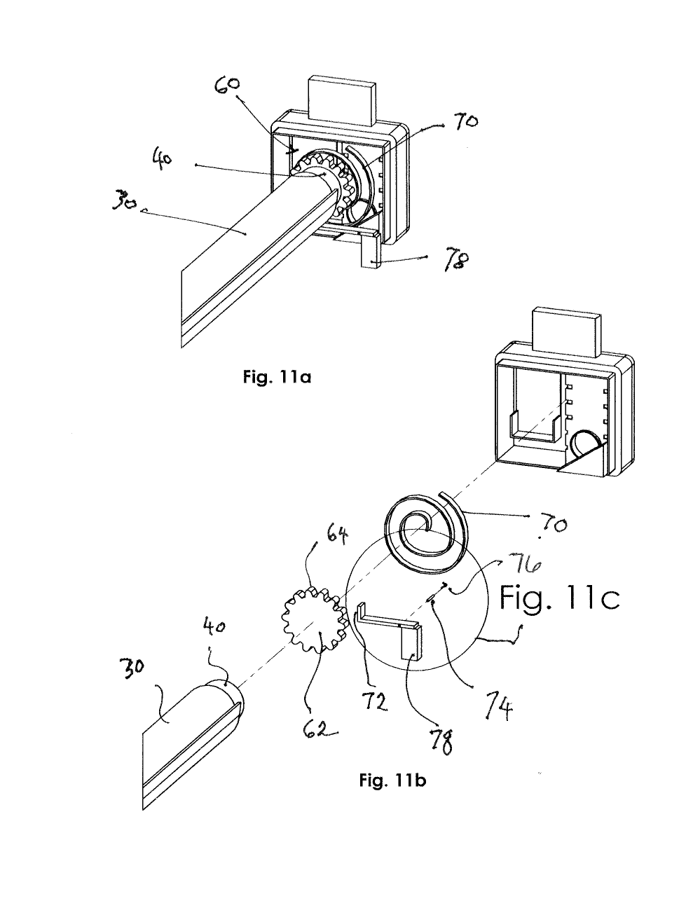

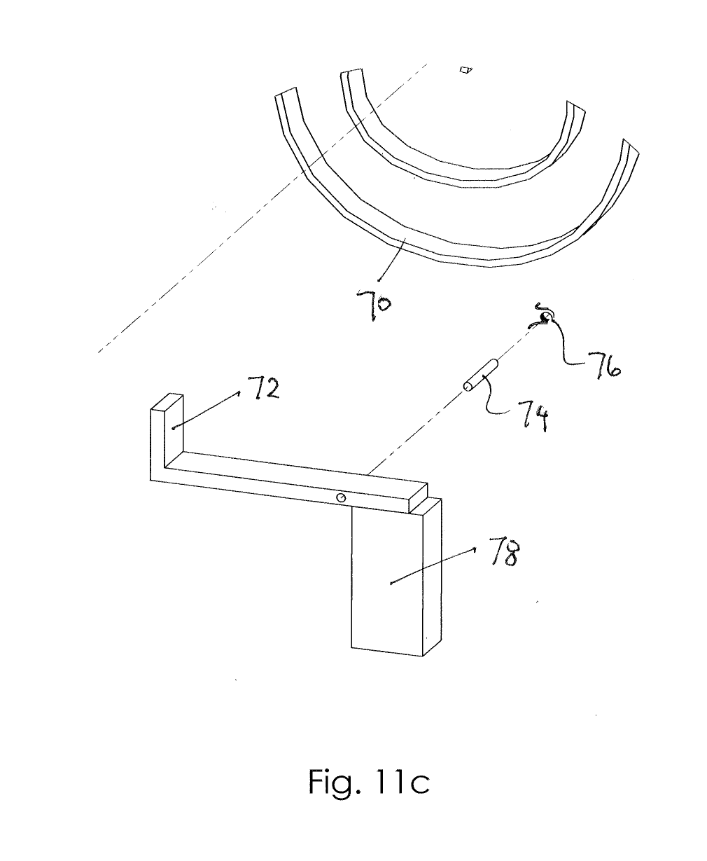

In yet another embodiment, a retraction assembly 60 is coupled to the spool 40, the retraction assembly 60 including a ratchet and pawl mechanism with a spring so that the shield panel 30 may be moved to a selected position (complete or partial deployment) and held there until a short downward tug may result in an automatic spring-induced retraction. It is understood that the embodiment described below is substantially similar to the structure first described above but adds additional mechanical structures to the invention. More particularly, the retraction assembly 60 includes a gear plate 62 having a plurality of teeth 64 and a torsion spring 70 operably coupled to the gear plate 62, the torsion spring 70 causing the gear plate 62 and consequently the spool 40 to retract quickly and automatically when the torsion spring 70 is actuated (FIG. 11b).

A pawl 72 is selectively engaged with the gear teeth 64 of the gear plate 62. When engaged, the pawl 72 is not actuated and the torsion spring 70 is likewise not actuated to turn the spool 40. However, when the pawl 72 is actuated (i.e. rotated), the pawl 72 is disengaged from the gear teeth 64 which enables the torsion spring 70 to retract the spool 40 and the shield panel 30 coupled to the spool 40. The pawl 72 is operably coupled to the torsion spring 70 via a pawl rod 74 and pawl spring 76 (FIG. 11b). Finally, a release member 78 is coupled to the pawl 72 by which a user may selectively rotate the pawl 72 and, as a result, cause the shield panel 30 to retract.

It is understood that the shield panel 40 may be pulled to a partially deployed configuration and the pawl 72 engages the gear plate 62 to prevent retraction of the shield panel 40. But then, operation of the release member 78 dislodge the pawl 72 from the teeth 64 which allows the torsion spring 70 to urge the spool 40 to retract. In another embodiment, a fast pull or tug on the shield panel 30 may be operable to disengage the gear teeth 64 and actuate the torsion spring 70 to retract the shield panel 30.

In use, the mounting base 29 may be mounted to the inner surface of the ceiling of an automobile, preferably adjacent an upper end of the automobile's windshield in front of the driver's seat. Selectively, the shield housing 20 may be coupled to the mounting base 29. Then, when driving into direct sunlight, a user may pull the sun shield panel 30 downwardly from the shield housing 20 or by operating the control buttons as described above, the tinting characteristics of the sun shielding panel 30 blocking the harsh glare of the sunlight and enabling the driver to drive more comfortably and with less risk of having an accident.

However, it is understood that in another embodiment (not shown), the entirety of movement of the spool 40 may be completely manual such as by pulling or pushing the handle 32.

In another embodiment (not shown), the entire windshield may be constructed of a tinted material, such as having a photochromic layer or overlay. Alternatively, the windshield may be constructed of a transition material in the manner of transition eyewear and that has the effect of darkening the degree of tinting when exposed to bright sunlight and reacting oppositely when sun exposure is reduced.

It is understood that while certain forms of this invention have been illustrated and described, it is not limited thereto except insofar as such limitations are included in the following claims and allowable functional equivalents thereof.

1. A solar shield apparatus for installation in a vehicle having a windshield and a cabin ceiling, comprising:
a mounting base fixedly mounted to the cabin ceiling of the vehicle;
a shield housing having a pair of mounting brackets removably coupled to said mounting base;
a spool positioned in said interior area of said housing and configured to move rotatably between a retracted configuration and a deployed configuration;
a shield panel having a thin plastic construction coupled to said spool, said shield panel being folded about said spool at said retracted configuration and being unfolded extending away from said shield housing at said deployed configuration;
wherein said shield panel is constructed of a heavy tinted configuration that is transparent yet resistant to solar light.

2. The solar shield apparatus as in claim 1, wherein:
said shield housing is coupled to said mounting member in a friction fit configuration for connection and disconnection therefrom;
said shield panel is positioned completely inside said shield housing when said spool is at said retracted configuration;
said shield panel extends away from said shield housing when said spool is at said deployed configuration.

3. The solar shield apparatus as in claim 1, wherein said shield panel includes photochromic material that darkens in color when exposed to ambient light.

4. The solar shield apparatus as in claim 1, further comprising a motor positioned in said interior area of said housing and electrically connected to said spool, said motor being operable to move said spool between said retracted configuration and said deployed configuration when energized.

5. The solar shield apparatus as in claim 4, further comprising a guide member having a proximal end coupled to a first end of said shield housing and having an elongate linear configuration extending away from said shield housing, said guide member defining a channel in operable communication with a side edge of said solar panel so as to guide said shield panel when said spool is moved from said retracted configuration to said deployed configuration.

6. The solar shield apparatus as in claim 1, further comprising a guide member having a proximal end coupled to a first end of said shield housing and having an elongate linear configuration extending away from said shield housing, said guide member defining a channel in operable communication with a side edge of said solar panel so as to guide said shield panel when said spool is moved from said retracted configuration to said deployed configuration.

7. The solar shield apparatus as in claim 1, wherein said shield panel includes a handle coupled to a free edge of said shield panel and extending away therefrom, said handle having a linear and ergonomic configuration by which said shield panel is urged manually by a user to move from said retracted configuration to said deployed configuration.

8. The solar shield apparatus as in claim 4, wherein said shield housing defines a slot having a dimension that allows said shield panel to pass therethrough when said spool is moved from said retracted configuration to said deployed configuration.

9. The solar shield apparatus as in claim 1, wherein said shield housing defines a slot having a dimension that allows said shield panel to pass therethrough when said spool is moved from said retracted configuration to said deployed configuration.

10. The solar shield apparatus as in claim 1, further comprising a retraction assembly operably coupled to said spool and operable to move said shield panel to a selected configuration intermediate said retracted configuration and said deployed configuration and, when actuated, automatically returns said shield panel to said retracted configuration.

11. A solar shield apparatus for installation in a vehicle having a windshield and a cabin ceiling, comprising:
a mounting base fixedly mounted to the cabin ceiling of the vehicle;
a shield housing having a pair of mounting brackets removably coupled to said mounting base;
a spool positioned in said interior area of said housing and configured to move rotatably between a retracted configuration and a deployed configuration;
a shield panel having a thin plastic construction coupled to said spool, said shield panel being folded about said spool at said retracted configuration and being unfolded extending away from said shield housing at said deployed configuration;
wherein said shield panel is constructed of a heavy tinted configuration that is transparent yet resistant to solar light;
wherein said shield housing defines a slot having a dimension that allows said shield panel to pass therethrough when said spool is moved from said retracted configuration to said deployed configuration.

12. The solar shield apparatus as in claim 11, wherein:
said shield housing is coupled to said mounting member in a friction fit configuration for connection and disconnection therefrom;
said shield panel is positioned completely inside said shield housing when said spool is at said retracted configuration;
said shield panel extends away from said shield housing when said spool is at said deployed configuration.

13. The solar shield apparatus as in claim 11, wherein said shield panel includes photochromic material that darkens in color when exposed to sunlight.

14. The solar shield apparatus as in claim 11, further comprising a motor positioned in said interior area of said housing and electrically connected to said spool, said motor being operable to move said spool between said retracted configuration and said deployed configuration when energized.

15. The solar shield apparatus as in claim 14, further comprising a guide member having a proximal end coupled to a first end of said shield housing and having an elongate linear configuration extending away from said shield housing, said guide member defining a channel in operable communication with a side edge of said solar panel so as to guide said shield panel when said spool is moved from said retracted configuration to said deployed configuration.

16. The solar shield apparatus as in claim 11, further comprising a guide member having a proximal end coupled to a first end of said shield housing and having an elongate linear configuration extending away from said shield housing, said guide member defining a channel in operable communication with a side edge of said solar panel so as to guide said shield panel when said spool is moved from said retracted configuration to said deployed configuration.

17. The solar shield apparatus as in claim 16, wherein said shield panel includes a handle coupled to a free edge of said shield panel and extending away therefrom, said handle having a linear and ergonomic configuration by which said shield panel is urged manually by a user to move from said retracted configuration to said deployed configuration.

18. The solar shield apparatus as in claim 11, further comprising a retraction assembly operably coupled to said spool and operable to move said shield panel to a selected configuration intermediate said retracted configuration and said deployed configuration and, when actuated, automatically returns said shield panel to said retracted configuration.

19. The solar shield apparatus as in claim 15, further comprising a retraction assembly having a ratchet, a pawl, and a torsion spring operably coupled to said spool 40 and operable to move said shield panel 30 to a selected configuration intermediate said retracted configuration and said deployed configuration and, with a sharp tug on the shield panel 30 or manipulation of the release member, automatically returns said shield panel to said retracted configuration.

20. The solar shield apparatus as in claim 14, further comprising user input controls electrically connected to said motor enabling a user to actuate said motor to cause spool to move from said retracted configuration to said deployed configuration and vice versa.
